(19) United States
(12) Patent Application Publication
(10) Pub. No.: US 2007/0257923 A1
(43) Pub. Date: Nov. 8, 2007

(54) Methods and apparatus for harmonization of interface profiles

(76) Inventor: Colin Whitby-Strevens, Ben Lomond, CA (US)

Correspondence Address: GAZDZINSKI & ASSOCIATES, P.C., 11440 WEST BERNARDO COURT, SUITE 375, SAN DIEGO, CA, 92127, US

(21) Appl. No.: 11/724,994

(22) Filed: Mar. 15, 2007

Related U.S. Application Data
(60) Provisional application No. 60/782,749, filed on Mar. 15, 2006.

(51) Int. Cl. G06F 13/14; H04L 12/28

(52) U.S. Cl. 345/520; 370/254

(57) ABSTRACT

Methods and apparatus for harmonizing or unifying at least partly heterogeneous device profiles within electronic devices. In one embodiment, processing or protocol layers within two or more separate device profiles (such as for example the Embedded and External profiles of the UDI specification) are harmonized, thereby permitting the use of a single logical paradigm (for at least one component or process) in place of two or more heterogeneous paradigms under the prior art. In the exemplary context of the aforementioned UDI specification, only a single implementation of the link layer framing logic of a source device, and the frame parsing logic of the sink is needed. Similarly, only one set of compliance tests for this unified paradigm need be developed and implemented.

### PRIORITY AND RELATED APPLICATIONS

This application claims priority to U.S. provisional application Ser. No. 60/782,749 filed Mar. 15, 2006 and entitled “Harmonized Data Link Layer for the UDI Embedded Profile Interface”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention relates generally to the field of data transfer between electronic devices. More particularly, in one exemplary aspect, the present invention is directed to simplifying data framing and protocol requirements via harmonization or unification of differing device protocols.

2. Description of Related Technology

A number of different media (e.g., video) data interface technologies are known under the prior art. One such technology is known as “UDI” or Unified Display Interface. The Unified Display Interface (UDI) specification (“Unified Display Interface (UDI) Specification”), Jul. 12, 2006, Revision 1.0a Final, which is incorporated herein by reference in its entirety) defines a digital video interface between a source (e.g., a video card) and a sink (e.g., a display device). UDI is generally based on the Digital Visual Interface (DVI), and is compatible with sink devices that adopt earlier interface standards, such as DVI and High-Definition Multimedia Interface (HDMI).

UDI is intended to provide a low-cost implementation, while maintaining compatibility with existing HDMI and DVI displays. Unlike HDMI, which is targeted at high-definition multimedia consumer electronics devices (e.g., television monitors and DVD players), UDI is more specifically focused towards computer monitor and video card manufacturers.

UDI provides higher bandwidth than its predecessor technologies (for example, up to 16 Gbs in its first version, as compared to 4.9 Gbs for HDMI 1.0). It also incorporates a type of Digital Rights Management (DRM) known as High-bandwidth Digital Content Protection.

DisplayPort is a competing standard (see DisplayPort Specification Version 1.0 and 1.1, 2006, VESA, each incorporated herein by reference in its entirety) which is also under development. DisplayPort is a digital display interface standard that defines a new digital audio/video interconnect, intended to be used primarily between a computer and its display monitor, or a computer and a home-theater system. The DisplayPort connectors support 1 to 4 data pairs and also carries audio and clock signals, with a transfer rate of 1.62 or 2.7 Gbps. The video signal supports an 8 or 10-bit pixel format per color channel. A bi-directional auxiliary channel is also provided that runs at a constant 1 Mbps, and serves management and device control functions using VESA EDID and VESA MCCS standards. The DisplayPort video signal is not compatible with DVI or HDMI.

The UDI environment generally consists of “sources” (which transmit a UDI signal) and “sinks” (which receive a UDI signal). A UDI “display” is defined as a special type of sink. A device which includes a source and sink function, as well as a re-transmission function (and maintains software transparency) comprises a UDI “repeater”. FIG. 1 illustrates the basic UDI source/sink/repeater architecture. UDI devices may have more than one UDI input and/or output. In such cases, each UDI input comprises a UDI sink, and each UDI output comprises a UDI source.

UDI is composed of two physical or electrical links: (i) a UDI Data Link, and (ii) a UDI Control Link, as illustrated in FIG. 2. The UDI Data Link comprises a unidirectional high-speed link used to transport e.g., media data. The UDI Control Link of FIG. 2 comprises a bidirectional lower-speed link used to transmit control, status and similar information.

The UDI data link carries for example the video data from a source to a sink. It is composed of either one (1) or three (3) differential data pairs referred to as “lanes”, plus a reference clock pair for the External Profile (described in greater detail subsequently herein). The data is carried on these data lanes via encoded symbols, with the symbol rate being related via a direct ratio to the video pixel data rate. This ratio is dependent on the pixel format and lane width. UDL symbol rates can range from the low-MHz range to a maximum frequency that is determined by the capabilities of the source and sink.

The UDI electrical interface is based on differential AC-coupled signals, allowing different DC bias voltages between a source and sink. This is also compatible with the sink bias requirements of HDMI.

The UDI Control Link (UCL) is used by a UDI Source to determine and control the capabilities and characteristics of the sink, including for example the reading of the E-EDID data structure residing in the sink. UDI sources read the sink's capabilities, and provide only the video formats supported by the sink. UCL is also used by the aforementioned optional High bandwidth Digital Content Protection (HDCP) technology.

UDI supports two different application profiles, relating to external devices and embedded or internal interfaces, respectively. The external application profile (UDI “External Profile”) defines requirements for external sink devices (for example, an external monitor connected by a cable cord to a desktop). The embedded application profile (UDI “Embedded Profile”) defines requirements for internal display interfaces (for example, notebooks having their own display screen). One salient feature of the Embedded Profile comprises a scalable link width choices, thereby allowing performance/cost/power flexibility.

In the External Profile, the data link consists of four differential data pairs-three for data, and one for a reference clock. The clock lane transmits a link clock at the symbol rate, which is used by the receiver as a frequency reference for data recovery on the three data lanes. The External Profile uses the TDMS 8B10B encoding scheme to achieve data encoding.

Generally speaking, 8B10B encoding involves replacing each 8 bit sequence in a transmission stream with one 10 bit symbol equivalent. The idea is to reconstruct the bit pattern such there are an equivalent number of 1's and 0's in a string of two symbols (to achieve DC balance) however, at the same time, so that there are not too many consecutive 0's or 1's in a row (so the receiver does not lose track of the bit edges, and thus can accomplish reasonable clock recovery). This property is also beneficial because it reduces inter-symbol interference—distortion of the current symbol caused by previously transmitted symbols. See, e.g., A. X. Widmer and P. A. Franaszek, “A DC-Balanced, Partitioned-Block, 8B/10B Transmission Code”; IBMJournal of Research and Development, Volume 27, Number 5, Page 440 (1983), which is incorporated herein by reference in its entirety.

The UDI External Profile protocol is compatible with the HDMI and HDCP standards. Salient differences between the External and the Embedded profiles include the use of TMDS encoding instead of ANSI 8B10B, a symbol rate clock reference is provided, and the video transport adds support for video sync pulses (Hsync, Vsync), data islands and (optional) HDCP data encryption.

FIG. 3a is a logical representation of an External Profile link pipeline in a UDI source. The pipeline starts with a Video Stream comprising three-color components (Red, Green and Blue) either 8 or 10 or 12-bits each, and each “pipe” terminates as a 1-bit serialized stream that is transferred to the sink using one of the three UDI lanes. The interposed functional blocks prepare the stream for transmission. The illustrated inputs and outputs, as well as the logical processing order, are reversed at the sink device.

The packer block converts the pixel rate video stream into a symbol rate byte stream so that it can be transported over the link. Since a ×3 link uses three UDI lanes, unlike the ×1 implementation (described below), this block is not required to merge the three streams into one, but rather keeps them separate from one another. There is one packer for the Red color component, one for the Green component and one for the Blue component. The incoming data is maintained in pixel order with the red component assigned to lane 2, the green component assigned to lane 1, and the blue component (and sync/blanking data) assigned to lane 0.

Each packer in the illustrated figure packs one of the color components from the pixel rate video stream into a symbol rate byte stream. In the case of 24 bpp (8 bits per component), each packer produces one output byte for each pixel clock of input. For 30 bpp (10 bits per component), each packer generates a group of 5 output bytes for every 4 pixel clocks of input. In the case of 36 bpp (12 bits per component), each packer generates a group of 3 output bytes for every 2 pixel clocks of input. Packing groups maintain these output/input ratios (1/1 for 24 bpp, 5/4 for 30bpp, 3/2 for 36 bpp), but their packing differs depending on the contents of the group.

For the external profile, the output byte groups may comprise all pixel data, of mixed pixel data and sync data, or of all sync data.

The illustrated Transport Assembly block receives the packed byte stream and the Byte DE from the packer at the symbol clock rate. It then inserts the comma sequences and data islands into the blanking, along with any necessary preambles and guard bands. The TA block also generates signals that determine whether the data stream is scrambled or encrypted, and which encoder is used (data or control) on each symbol. An HDCP encryption enable signal is inserted on lane 2. The HDCP Encryption is optional. If used, the three 8-bit streams are joined and encrypted as a single 24-bit stream. The result is then split back into three 8-bit streams prior to scrambling and encoding. When encryption is enabled, the HDCP 1.1 specification is used (i.e., 24 bits of video data and 9 of 12 bits of auxiliary data).

In the illustrated pipeline, data islands are inserted into blanking periods of the video stream to form a video transport stream composed of video periods and auxiliary data periods.

The illustrated 8-bit Scrambler blocks scramble the pixel information within active periods, and scramble the auxiliary data within data island periods.

The TMDS (Transition Minimized Differential Signaling) 8B10B Encoder blocks take each byte stream and encode it into a 10-bit stream using the TMDS 8B10B encoder. As is well known, TMDS incorporates a coding algorithm which has reduced electromagnetic interference over copper cables, and provides very robust clock recovery at the receiver to achieve high skew tolerance for driving longer cable lengths as well as shorter cables. TDMS encoding in one variant comprises a two-stage process that uses ten bits to represent eight bits. In the first stage, each bit is either XOR or XNOR transformed against the previous bit, while the first bit is not transformed at all. The encoder selects XOR and XNOR by determining which will result in the fewest transitions; the ninth bit is added to indicate which of XOR or XNOR was used. In the second stage, the first eight bits are optionally inverted to balance ones and zeroes, and therefore the sustained average DC level. The tenth bit is added to indicate whether the aforementioned inversion took place. The 10-bit TMDS symbol can represent either an 8-bit data value during normal data transmission, or 2 bits of control signals during screen blanking.

The 10-bit to 1-bit Serializer blocks of FIG. 3a take each 10-bit data stream and serialize it into a 1-bit stream; this is then transmitted on the corresponding UDI lane, outputting the least significant bit (1 sb) first. In this configuration, the red stream is output on lane 2, the green stream is output on lane 1 and the blue stream is output on lane 0.

In the UDI Embedded Profile, the data link consists of either one or three data pairs, and there is no clock lane. Each pair transfers data and clocking information from source to sink, so that the receiver recovers the link clock from the data stream itself (this is called an inferred clocking approach). The Embedded Profile uses the ANSI 8B10B encoding scheme to achieve 8B 10B encoding.

FIG. 3b illustrates the “one-lane” Embedded Profile (×1 link) pipeline in a UDI source. The Embedded pipeline starts with a Video Stream composed of three color components (Red, Green and Blue), either 6 or 8-bits each. It ends as a 1-bit serialized stream that is transferred to the sink using the UDI link. As for the External profile described above, the inputs and outputs, as well as the logical processing order, are reversed at the receiver.

The Video Stream comprises frames of pixels and blanking characters at the pixel clock rate. The pixel information consists of the Red, Green and Blue color components. These can be presented in either 6 or 8-bit per color component.

The Color Serializer Packer (CSP) of FIG. 3b converts the pixel rate video stream into a symbol rate byte stream, which is then transported over the link. This CSP block first serializes the color component (RGB) streams into a single stream. These three streams are merged into a single pixel stream with the red component first, green component second, and blue component last, within each pixel. Pixels are maintained in their incoming order. For example, the serializer block orders the first pixel as the Red component, then the Green component, and finally the Blue component. This process is then repeated for the subsequent pixels. This CSP block then packs the serialized color component stream into a byte stream. When the pixel components are 8-bit, each pixel component is placed in a byte. However, if the pixel component is 6-bits, 2 bits are unused in each byte. The next pixel component's lsbs are “packed” into the unused space of the current byte, and the remaining bits are placed in the lsbs of the next byte. This process is known as packing; i.e., the serialized color component stream is packed into a byte stream. The UDI sink performs the reverse of this process, unpacking the stream back into either an 8 or 6-bit stream which then is de-serialized into three component streams.

The Transport Assembly (TA) block receives the packed byte stream and the Byte DE from the CSP at the symbol clock rate. It then adds the Field/Frame bytes and control signals; these indicate where control symbols and the training sequence are to be inserted. An SVB sequence is placed at the beginning of each frame, and an SHB sequence is placed the beginning of each line. An SHA sequence is placed at the beginning of each active period. The training sequence and Field/Frame bytes are inserted during vertical blanking (VB). Additional signals output by this TA block are used to determine which bytes in the data stream are scrambled and whether each byte is encoded as data or control.

The 8-bit Scrambler uses the signals from the Video Transport block (VTB), and scrambles all the bytes in the stream (with the exception of the control bytes and training sequence).The ANSI 8B10B Encoder block takes the byte stream and encodes it into a 10-bit stream using the ANSI 8B10B encoder algorithm. The control signal input is used to indicate whether a byte is to be encoded as control or data.

The 10-bit to 1-bit Serializer block receives the 10-bit data stream and serializes it into a 1-bit stream; this is transmitted on the UDI link with the 1sb first.

The ×3 or 3-lane Embedded Profile (FIG. 3c) implementation is generally the same as the Embedded ×1 link described above with respect to FIG. 3b, except that each of the 3 color components are not required to be serialized into a single stream. Instead, each color component remains as a separate stream for this implementation (since three UDI lanes are utilized, one lane for each color component).

The ×3 pipeline starts with a Video Stream composed of three color components (Red, Green and Blue) either 8, 10 or 12-bits each and each pipe ends as a 1-bit serialized stream that is transferred to the sink using one of the three UDI lanes. The blocks in between prepare the stream for transmission. The inputs and outputs, as well as the logical processing order, are reversed at the sink.

As will be recognized from the foregoing discussion, an appreciable degree of heterogeneity exists between the External and Embedded Profiles (and even the one-and three-lane Embedded profile implementations) in terms of their pipelines and protocols. The UDI specification generally provides a common architectural framework spanning the requirements of multiple application segments; however, to manage the diversity of application requirements without burdening all implementations (e.g., making certain implementations more complex than otherwise required by forcing support of unused features or capabilities), UDI defines the Embedded and External profiles. While there are core requirements that are applicable across profiles, there are also several profile-specific requirements. Hence, the UDI specification is to some degree purposely “un-unified”. This is also true of the link layer implementations of each, which are more particularly adapted for their intended target applications.

Based on the foregoing, it would be beneficial to create a single, “universal” UDI implementation (including 8B10B encoding) which operates across all platforms, yet still remains compatible for use with DVI and HDMI devices. What is needed are methods and apparatus for extending the ANSI 8B10B encoding scheme required by the Embedded Profile so as to allow symbols to be transported across the link with a framing structure identical to the structure required in the UDI External Profile. Ideally, this methodology and apparatus would also be more generally applicable and extensible beyond merely the context of UDI Profiles.

### SUMMARY OF THE INVENYION

The present invention satisfies the foregoing needs by providing, inter alia, improved methods and apparatus for unification and harmonization of device or component profiles, such as e.g., those of the UDI specification previously described.

In a first aspect of the invention, a data device adapted to communicate with a second device over an interface is disclosed. In one embodiment, the device comprises: a processor; a storage device in data communication with the processor; an interface adapted for data communication with the second device; and a computer program operative to run on the processor. The computer program comprises a substantially unified data link layer protocol adapted to support two at least partly heterogeneous device profiles.

In one variant, the data comprises video data, and the protocol comprises a unified display interface (UDI) compliant protocol. The heterogeneous device profiles comprise e.g., the UDI Embedded Profile and the UDI External Profile.

In another variant, the data device comprises a unified display interface (UDI) source, and the second device comprises a unified display interface (UDI) sink.

In a second embodiment, the data device comprises: a processor; a storage device in data communication with the processor; a display or rendering device; an interface adapted for data communication between the processor and the display or rendering device; and a computer program operative to run on the processor. The computer program comprises a substantially unified data link layer protocol adapted to support two at least partly heterogeneous device profiles.

In one variant, the device comprises a portable computer, the display device comprises a liquid crystal (LCD) or thin-film transistor (TFT) display, and the interface comprises a UDI-compliant interface.

In a second aspect of the invention, a method of unifying a plurality of at least party heterogeneous device profiles is disclosed. In one embodiment, the method comprises: identifying two or more of the profiles requiring harmonization; evaluating the two or more profiles to be harmonized in terms of at least their requirements and capabilities; and harmonizing the two or more profiles so as to provide at least one common functional entity.

In one variant, the heterogeneous device profiles comprise the UDI Embedded Profile and the UDI External Profile, and the evaluating comprises evaluating data link layer protocols associated with respective ones of the Profiles.

In another variant, the at least one common entity comprises at least one of: (i) a first implementation of a link layer framing logic, and (ii) a second implementation of a link layer frame parsing logic; and the first and second implementations of the framing and parsing logic each support each of the device profiles.

In yet another variant, at least one of the implementations comprises using 8B10B symbol encoding to transport video data and related information using a video framing structure associated with only one of the device profiles.

In a third aspect of the invention, a method of operating a device adapted to communicate data is disclosed. In one embodiment, the data comprises video data, and the method comprises: assigning a plurality of control symbols associated with the video data; transmitting at least some of the control symbols for each of a plurality of data lanes; determining if any of the plurality of symbols are present on more than one of the plurality of lanes; and if present, terminating a video data period.

In one variant, the method further comprises transmitting subsequent ones of the control symbols by: extending at least one of the subsequent symbols to generate an extended value; scrambling the extended value to generate a second extended value; encoding the second value as a corresponding symbol; and transmitting the encoded symbol.

In another variant, the device comprises a UDI-compliant device, and the method further comprises: evaluating the second extended value; and if the second extended value comprises a designated symbol, then substituting a second designated symbol therefor.

In a fourth aspect of the invention, a video data processing system is disclosed. In one embodiment, the system comprises: a video data source; and a video data sink; wherein the source comprises a first implementation of a link layer framing logic, and the sink comprises a second implementation of a link layer frame parsing logic, the first and second implementations of the framing and parsing logic each supporting a plurality of device profiles.

In one variant, the plurality of device profiles comprise (i) the UDI Embedded Profile; and (ii) the UDI External Profile.

In another variant, at least one of the implementation comprises using 8B10B symbol encoding to transport video data and related information using a video framing structure associated with one of the device profiles.

In still another variant, the link layer framing logic and the link layer frame parsing logic can be compliance-tested using a common testing framework.

In a fifth aspect of the invention, a data interface adapted to support multiple device profiles is disclosed. In one embodiment, the interface comprises a video data interface compliant with the UDI specification, and the profiles comprise at least the Embedded and External Profiles thereof. In another embodiment, the interface comprises both source and sink capability (e.g., a transceiver).

In a sixth aspect of the invention, a method of encoding data so as to form “virtual” lane assignments or modes (e.g., one-lane, four-lane, etc.) is disclosed.

Other features and advantages of the present invention will immediately be recognized by persons of ordinary skill in the art with reference to the attached drawings and detailed description of exemplary embodiments as given below.

### BRIEF DESCRIPTION OF THE DRAWINGS

FIG. 1 is a block diagram illustrating a prior art UDI source-sink arrangement.

FIG. 2 is a block diagram illustrating the control and data paths associated with the prior art UDI source-sink arrangement of FIG. 1.

FIG. 3a is a block diagram illustrating an exemplary prior art UDI External Profile pipeline.

FIG. 3b is a block diagram illustrating an exemplary prior art UDI Embedded Profile pipeline (one lane).

FIG. 3c is a block diagram illustrating an exemplary prior art UDI Embedded Profile pipeline (three-lane).

FIG. 4 is a logical flow diagram illustrating one embodiment of the generalized methodology of device profile harmonization according to the present invention.

FIGS. 5a-5e are logical flow diagrams illustrating various aspects of one embodiment (three-lane) of the unified encoding methodology of the present invention.

FIGS. 6 is a logical flow diagram illustrating another embodiment (one-lane) of the unified encoding methodology of the present invention.

FIGS. 7 is a logical flow diagram illustrating yet another embodiment (four-lane) of the unified encoding and methodology of the present invention.

FIG. 8 is a block diagram of one exemplary embodiment of an electronic device having unified link layer capability according to the present invention.

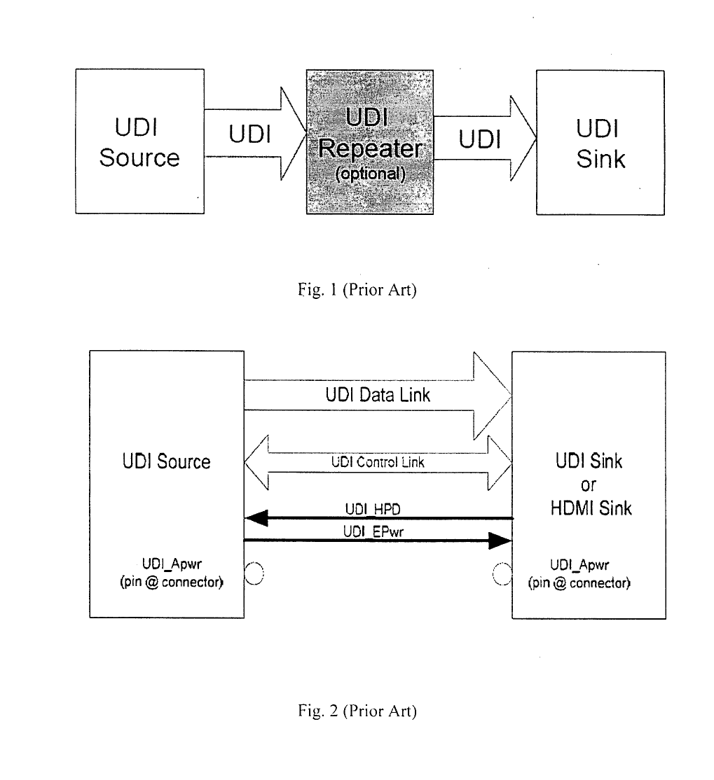

### DETAILED DESCRIPTION OF THE INVENTION

As used herein, the terms “client device” and “end user device” include, but are not limited to, set-top boxes (e.g., DSTBs), personal computers (PCs), and minicomputers, whether desktop, laptop, or otherwise, and mobile devices such as handheld computers, PDAs, video cameras, personal media devices (PMDs), such as for example an iPod™, or Motorola ROKR, LG “Chocolate”, and smartphones, or any combinations of the foregoing.

As used herein, the term “coding” refers without limitation to any scheme or mechanism for causing data or sets of data to take on certain meanings or assume certain values. Examples of coding include 8B10B, TDSM, Manchester coding, Barker coding, and Gray coding.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

As used herein, the term “DVI” (digital video interface) refers generally to any type of interface (e.g., hardware and/or software) adapted to provide interface and/or conversion between different formats or domains, including without limitation interfaces compliant with the Digital Display Working Group (DDWG) DVI specification (e.g., DVI-A, DVI-D, and DVI-I). For example, using a DVI connector and port, a digital signal sent to an analog monitor is converted into an analog signal; if the monitor is digital, such as a flat panel display, no conversion is necessary. A DVI output is often an option in hardware that provides a high-definition TV (HDTV) output which includes copy protection.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components.

As used herein, the terms “network” and “bearer network” refer generally to any type of data, telecommunications or other network including, without limitation, data networks (including MANs, PANs, WANs, LANs, WLANs, micronets, piconets, internets, and intranets), hybrid fiber coax (HFC) networks, satellite networks, and telco networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, 802.11, ATM, X.25, Frame Relay, 3GPP, 3GPP2, WAP, SIP, UDP, FTP, RTP/RTCP, H.323, etc.).

As used herein, the term “network interface” refers to any signal, data, or software interface with a component, network or process including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™), radio frequency tuner (e.g., in-band or OOB, cable modem, etc.), WiFi (802.11a,b,g,n), WiMAX (802.16), PAN (802.15), or IrDA families.

As used herein, the term “wireless” means any wireless signal, data, communication, or other interface including without limitation Wi-Fi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

### Overview

The present invention provides, inter alia, methods and apparatus for harmonizing or unifying processing or protocol layers within two or more separate device profiles, such as for example the Embedded and External profiles of the UDI specification previously described herein.

Advantageously, the present invention permits the use of a single logical paradigm (for at least one component or process) in place of two or more heterogeneous paradigms under the prior art. For example, in the exemplary context of the aforementioned UDI specification, only a single implementation of the link layer framing logic of a source device, and the frame parsing logic of the sink (e.g., timing controller or TCON) is needed, as compared to two at least partly distinct implementations under the prior art approach.

Similarly, only one set of compliance tests for this unified paradigm need be developed and implemented.

### DETAILED DESCRIPTION OF EXEMPOARY EMBODIMENTS

Exemplary embodiments of the present invention are now described in detail. While these embodiments are discussed in terms of source and sink devices that are compliant with the Unified Display Interface (UDI) specification previously described, it will be recognized by those of ordinary skill that these embodiments are merely illustrative, and the present invention is in no way limited to a UDI environment. Various other applications and embodiments are also possible in accordance with the invention, and considered to be within the scope thereof. For example, aspects of the present invention can be adapted to the aforementioned DisplayPort or HDMI environments.

Additionally, while the “8B10B” and TDMS encoding previously described forms the basis of the exemplary embodiments, the invention is in no way so limited, and other types of coding can be used.

Moreover, while discussed primarily in the context of a basic two-device or entity topology (e.g., a source device or process, and a sink device or process), it will be appreciated that other topologies (e.g., one sink, multiple sources, one source, multiple sinks, sources or sinks with multiple daughter processes, etc.) may be used consistent with the invention. Moreover, one or more interposed repeaters as previously described may be used consistent with the invention.

Additionally, while the terms “source” and “sink” are used in the present context, this should in no way be considered limiting; i.e., a device or other entity may or may not comprise a logical or physical endpoint within the topology or be ascribed a particular function therein, such as in the case where an entity acts as both a source and sink. It is also envisaged that a source or sink process may have duality and/or switch to an alter-ego; such as where a given source process is also configured to operate as a sink process under certain conditions.

Furthermore, while some embodiments are shown in the context of a wired data bus or connection (e.g., a cable), the invention is equally applicable to wireless alternatives or interfaces such as, without limitation, 802.11, 802.16, UWB/PAN, infrared or optical interfaces, and the like. As can be appreciated, the signaling and protocols described herein can be transmitted across a wireless physical layer as well as a wired one, which also adds additional flexibility in the context of mobile client devices or personal media devices (PMDs) and the like.

Similarly, while the exemplary UDI interface prescribes a given wired interface configuration, others may be used with equal success depending on the host source and sink configurations and environments.

Generalized Methodology

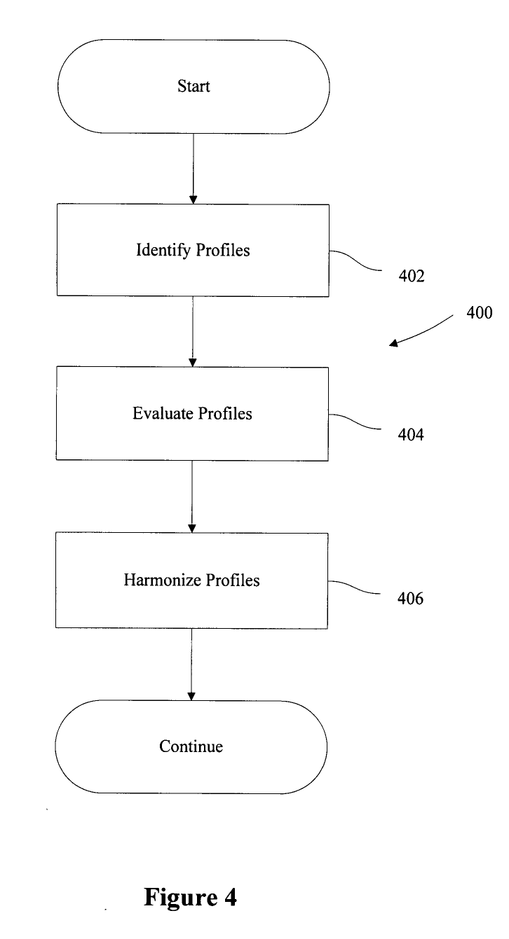

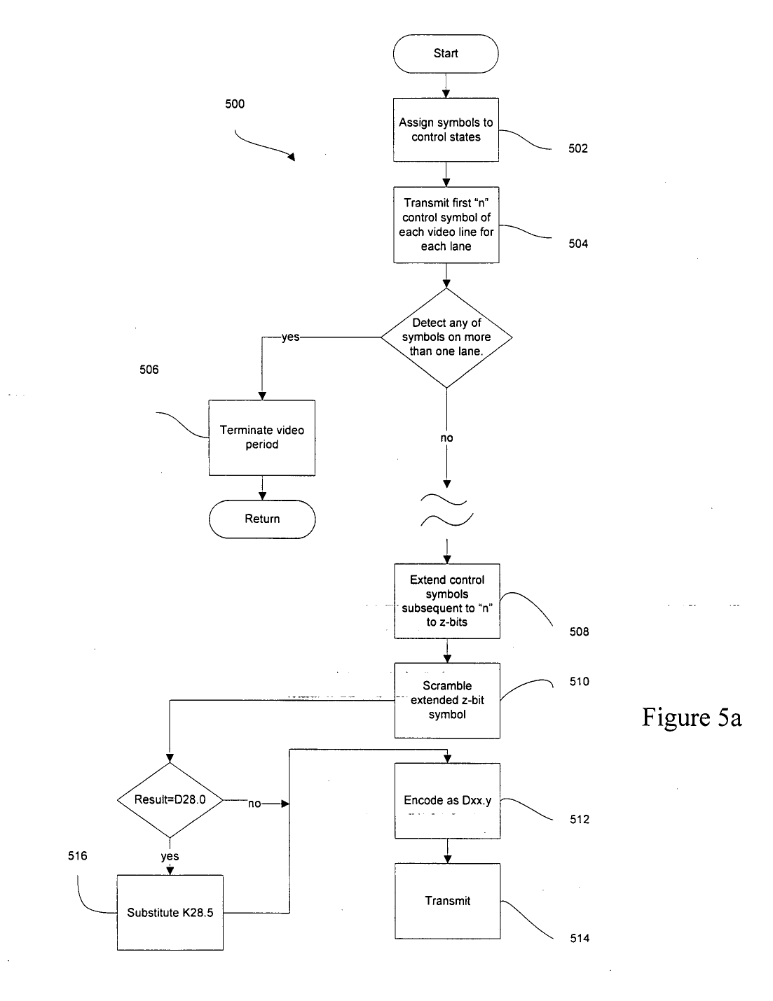

FIG. 4 illustrates one embodiment of the generalized method of unifying or harmonizing device profiles according to the invention.

At a high level of abstraction, the exemplary method 400 of FIG. 4 comprises finding commonalities or features that are common to or are adaptable so that two or more functions can be serviced by a fewer number of devices, protocols or processes. As previously described, the exemplary UDI context comprises two device profiles (Embedded and External) which under the prior art require substantially discrete approaches to data link layer framing and parsing for video data. However, through the unification or harmonization approach of FIG. 4, only a single implementation of the link layer framing logic of the source and the link layer frame parsing logic of the sink is needed, and these implementations apply equally to both the Embedded and External Profiles.

As shown in FIG. 4, the first step 402 of the generalized methodology comprises first identifying two or more “profiles” requiring harmonization. As used in the present context, the term “profile” is intended to broadly encompass without limitation any configurations or aggregations of features or capabilities common to a given environment. In the exemplary UDI context, the Embedded and External profiles are effectively closely related variants of one another, one intended for external sink devices (e.g., an external monitor connected by a cable cord to a desktop computer), while the other is intended for internal display interfaces (e.g., notebook or mobile computers having their own display screen). However, other types and relationships of profiles are envisaged and may be harmonized according to the present methodology, including for example those based on application (e.g., fixed versus portable profiles, different peripheral profiles such as for printers, headsets, etc. as in the well known Bluetooth wireless context), those based on equipment configuration (e.g., one hardware and/or software environment versus another), and so forth.

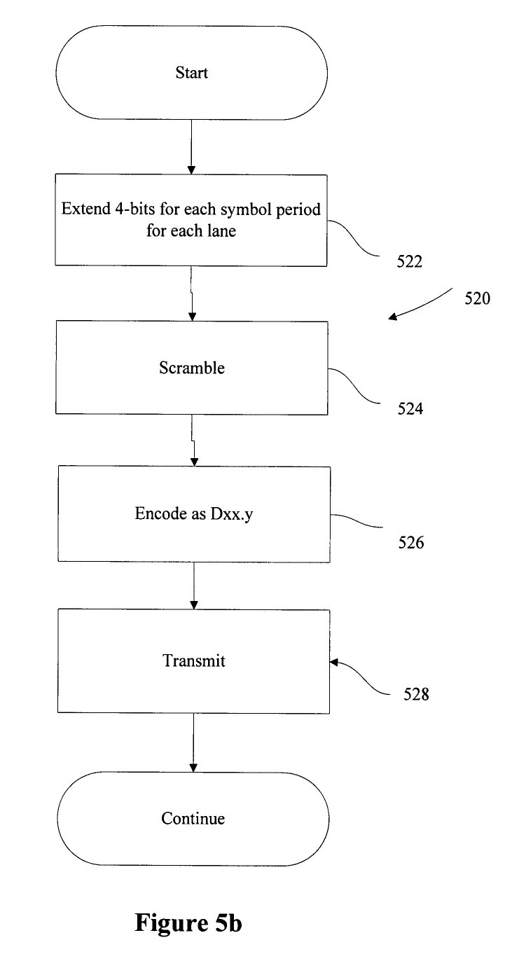

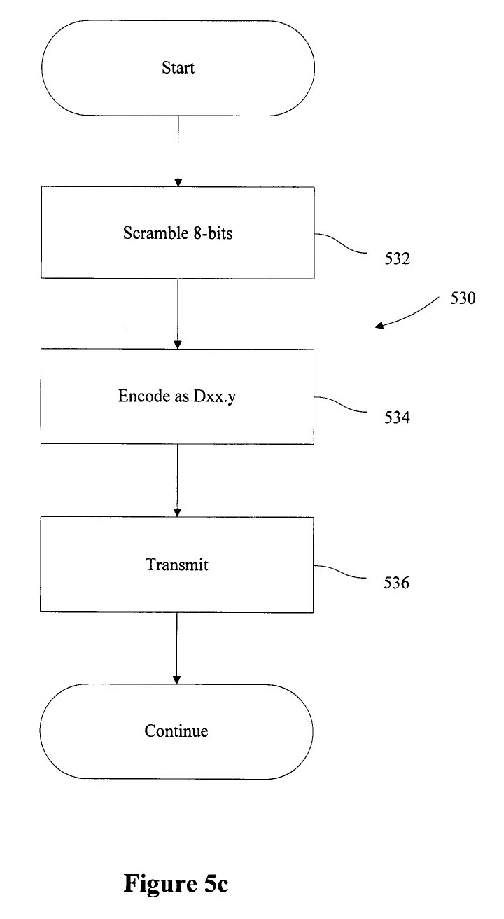

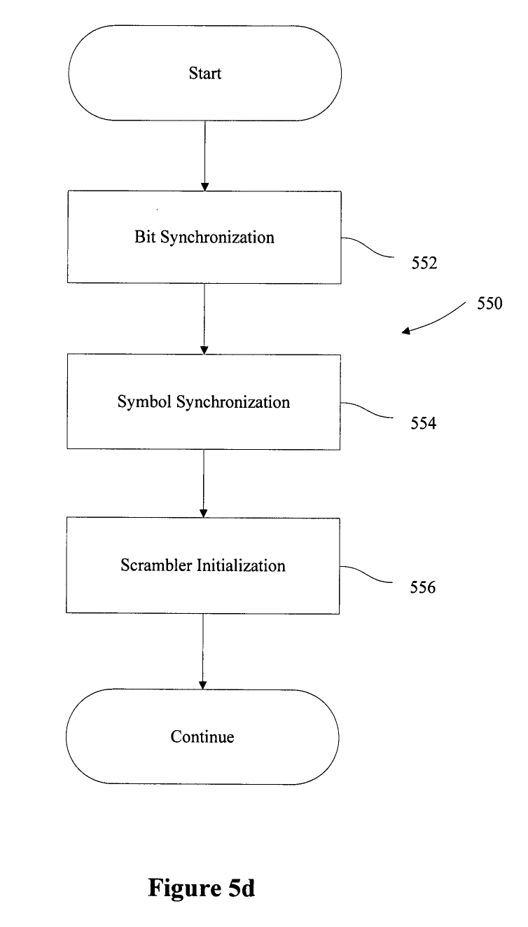

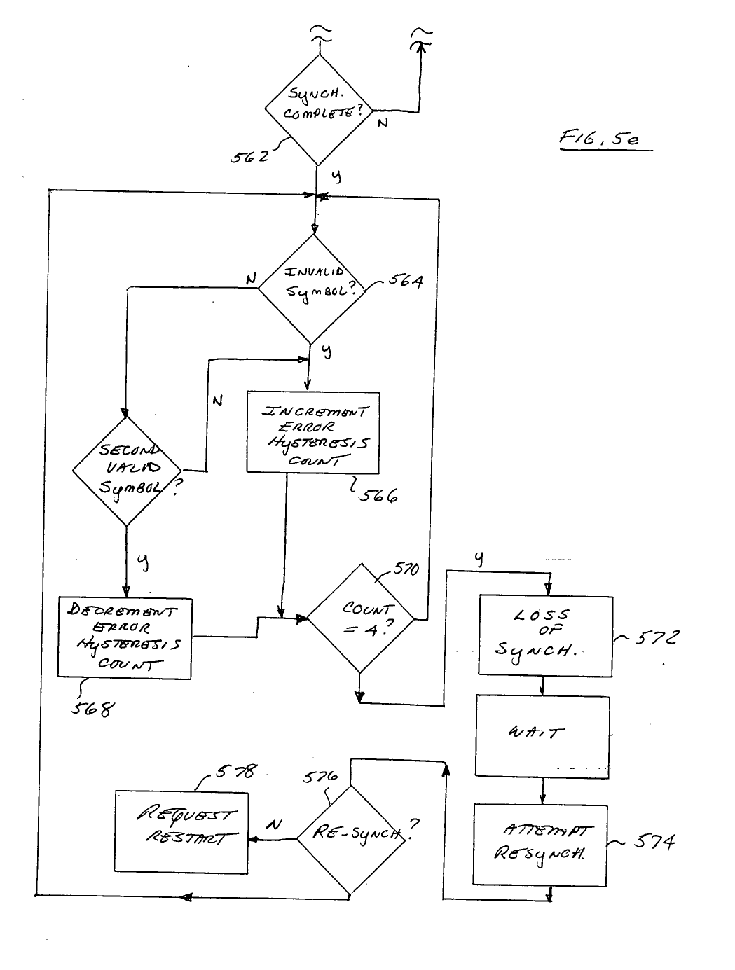

Next, the two or more profiles to be harmonized are evaluated in terms of their requirements and capabilities per step 404. As described below with respect to FIGS. 5a-5e, in the exemplary UDI context, symbol-to-symbol equivalence between the profiles is the desired attribute, and hence the data transmission and control functions associated with the profiles are evaluated to identify requirements and available facilities within each of the profiles.

Lastly, per step 406, the two or more profiles are harmonized or unified so that a fewer number of components, processes, or logical functions are required in order to implement each of the profiles. In simple terms, one or more portions of a profile are made “universal” to at least some degree with corresponding portion(s) of the other relevant profiles. For example, the exemplary UDI harmonization described in greater detail below, heterogeneous or different implementations of the link layer framing logic of the UDI source (and the link layer frame parsing logic of the UDI sink) are replaced with a common or unified implementation that services all of the requirements of both the Embedded and External Profiles.

Exemplary UDI Implementations

Referring now to FIGS. 5a-7, exemplary UDI-based implementations of the foregoing generalized methodology are described in detail.

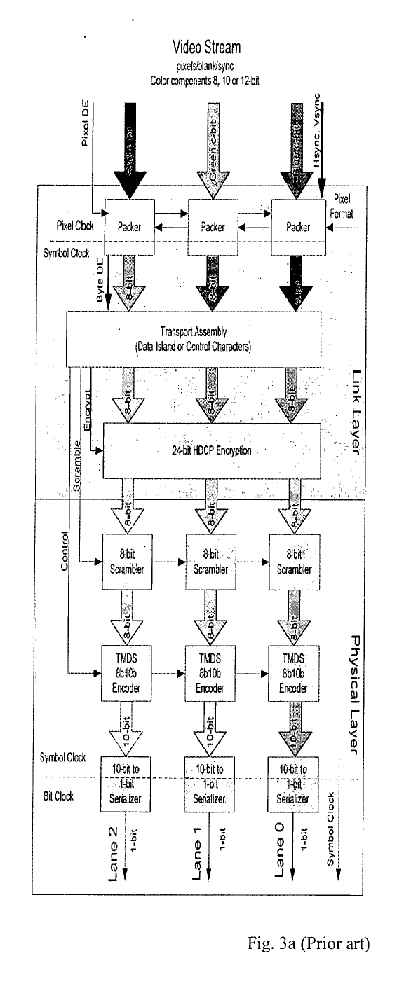

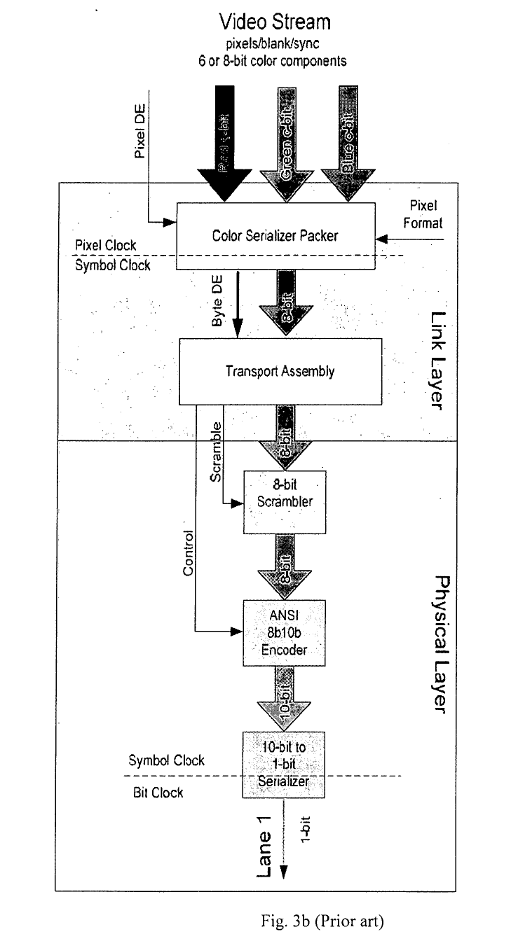

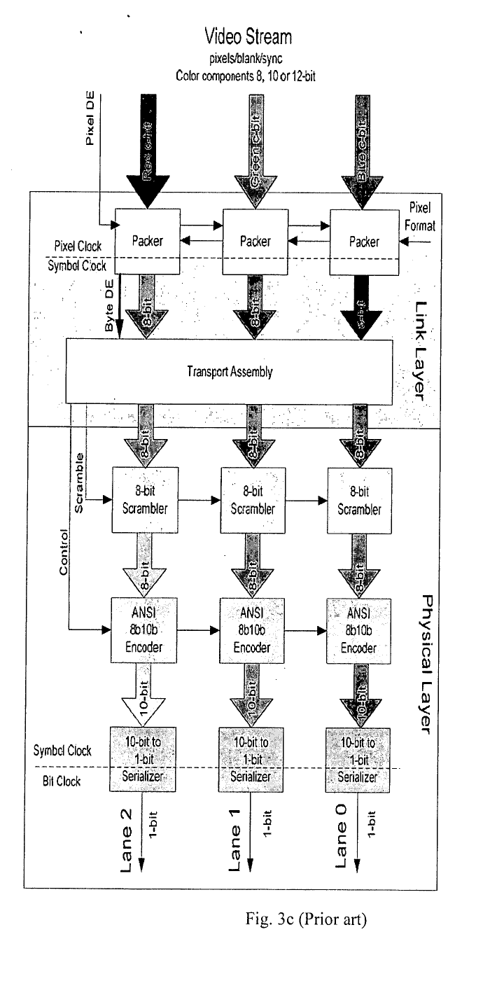

In the context of the aforementioned UDI Embedded and External Profiles, various requirements must be met in order to provide symbol-by-symbol equivalence of the Embedded Profile framing to the External Profile framing (as well as to support HDMI and DVI). Specifically, the data link layer for UDI (see FIGS. 3a-3c) requires symbols for transmitting the following types of information: a) synchronization or control symbols—four values need to be communicated; b) video guard band symbols—two distinct symbols needed, one for lanes 0 and 2, one for lane 1; c) data island guard band symbols—one distinct symbol needed, transmitted on lanes 1 and 2 (lane 0 carries a sync symbol); d) data island data values—each symbol carries one of 16 possible values; and e) video data—each symbol carries one of 256 possible values.

The encoding must also meet the following requirements: f) symbols must be chosen so that the end of video data can be recognized explicitly (i.e. the following control symbols must be distinct from video data symbols); g) symbols must be chosen so that the data island guard band can be recognized explicitly (i.e. the symbols are distinct from data symbols and control symbols); h) use of scrambling should be maximized; i) symbols incorporating a comma sequence must be present at frequent intervals (at least 12 times per frame) to allow the receiver to achieve symbol alignment within one frame period after achieving bit alignment; j) the disparity rules of the IBM 8B10B or other such encoding must be respected; and k) the repeated use of K28.7 should be avoided (as recommended in Widmer and Franaszek, referenced and incorporated previously herein).

Accordingly, the exemplary UDI implementation of the invention is adapted to satisfy these requirements through use of, inter alia, a unified link layer architecture.

Three-Lane Implementation

Referring now to FIGS. 5a-5e, an exemplary “three-lane” implementation for harmonization of the aforementioned Embedded and External Profiles is described in detail.

In the exemplary embodiment of FIG. 5a (control data), four distinct “K” symbols are assigned as control data (step 502), one to each of the four possible values of the two control bits for each of the three lanes (e.g., HSYNC and VSYNC for lane 0, CTL1:0 for lane 1 and CTL3:2 for lane 2), as shown in Table 1.

TABLE 1

| Control Bit Values | Symbol |
|---|---|
| 00 | K28.0 |
| 01 | K28.1 |
| 10 | K28.2 |
| 11 | K28.3 |

The symbols selected for this purpose in the illustrated embodiment comprise K28.0, K28.1, K28.2 and K28.3, for ease of decoding, although it will be appreciated that other may be used as well consistent with the invention. The first n (here, n=four) control symbols of each video line are transmitted using this encoding for each lane without scrambling per step 504. The detection of any of these four symbols on more than one lane terminates a video data period (meeting requirement f) discussed above), per step 506.

Subsequent control symbols in a line (including data island preambles) are transmitted by first being extended with zeros to generate an exemplary 8 bit value (still in the range 0-3) per step 508, scrambled to generate an 8-bit value in the range 0-255 (step 510), encoded as the corresponding Dxx.y symbol per step 512, and transmitted per step 514.

If, at any time, the result of scrambling comprises the symbol D28.0, then the symbol K28.5 is substituted for it per step 516. This is to provide a comma sequence for receiver symbol synchronization; however, other methods may be used as well.

Two distinct K symbols are assigned as video guard band symbols in the illustrated embodiment. The symbols selected comprise K23.7 (for transmission on data lanes 0 and 2) and K27.7 (for transmission on data lane 1), although others may be used. The video guard band symbols are not scrambled in this embodiment.

In terms of data island guard band symbols, four distinct K symbols are assigned in this embodiment, one to each of the four (4) possible values of the two control bits for each of the three lanes (HSYNC and VSYNC for lane 0, CTLI:0 for lane 1 and CTL3:2 for lane 2). The symbols selected for this embodiment are K29.7, K30.7, K28.4 and K28.6. See Table 2 below.

Note that CTL1:0 and CTL3:2 are always zero in this embodiment, so the symbol transmitted on lanes 1 and 2 is always K29.7.

The data island guard band symbols are not scrambled.

TABLE 2

| Control Bit Values | Symbol |
|---|---|
| 00 | K29.7 |
| 01 | K30.7 |
| 10 | K28.4 |
| 11 | K28.6 |

For the data island values (method 520 of FIG. 5b), the four-bits for each symbol period for each lane (HSYNC, VSYNC, packet header bit and 0/1 bit for lane 0, packet data for lanes 1 and 2) are extended with zeros in the illustrated embodiment in order to generate an 8 bit value in the range 0-15 (2⁴) per step 522, scrambled to generate an 8-bit value in the range 0-255 (2⁸) per step 524, encoded as the corresponding Dxx.y symbol per step 526, and transmitted per step 528. In contrast to the control symbols previously described, no substitution of D28.0 by K28.5 is performed.

For the video data (method 530 of FIG. 5c), the eight bits for each symbol period for each lane are scrambled to generate an 8-bit value in the range 0-255, encoded as the corresponding Dxx.y symbol, and transmitted. Again, no substitution of D28.0 by K28.5 is performed.

The illustrated embodiment also includes a disparity control mechanism. Specifically, the transmitter maintains the running disparity state, and initializes this to−1 before transmitting the very first symbol when starting transmission on a new connection. At the end of transmitting a symbol, the running disparity must be −1 or +1. The negative or positive encoding of the following symbol is selected following the rules of the aforementioned IBM 8B10B encoding. The running disparity is only reset in the case where transmission ceases, and then is restarted for some reason (e.g. exit from a low power or sleep mode, or a new connection detected).

The scrambler of the present embodiment is identical to that used for the UDI External Profile, previously described. The scrambler is advanced for every symbol transmitted, whether or not the symbol was itself scrambled. The transmitter and receiver scramblers are reset to 0xFFFF after transmitting/receiving two or more of any of K28.0, K28.1, K28.2 and K28.3 (the control symbols at the start of each line) consecutively on lane 0.

In another embodiment, a scrambler configuration of the type well known in the art that allows for receiver training, yet avoids the need for frequent resets as in the previous description (i.e., less frequently than after transmitting/receiving two or more of any of K28.0, K28.1, K28.2 and K28.3 consecutively on lane 0).

In terms of coding errors, the receiver of the exemplary three-lane embodiment applies an exemplary error detection and processing scheme. In this scheme, the receiver first performs the checks defined in Widmer and Franaszek, although it will be appreciated that other coding/error identification or correction schemes may be substituted. In addition, the receiver verifies that any control or data symbol is received in an appropriate context. Should any received symbol fail any of these checks, then it is designated an invalid symbol and is not passed to the higher layers.

When receiving data, an invalid symbol is ignored and the previous data value repeated (or value 0×00 for the first data value in a data context), otherwise the invalid symbol is ignored. The context is changed (e.g. from video data to control) if two of the three lanes provide valid symbols for the new context.

Whenever an invalid symbol is detected, the receiver increments a per-lane error count and a per-lane error hysteresis count (see discussion below). The per-lane error count contains 8 bits arid sticks at 255. It can be read as a UCSR and is zeroed whenever read.

Synchronization of a UDI “sink” or receiver take place in the following sequence 550 (FIG. 5d): a) bit synchronization (e.g., using the edges of the incoming data) per step 552; b) symbol synchronization (e.g., using the 7-bit comma sequence embedded in the K28.5 symbols) per step 554; and c) scrambler initialization per step 556.

Loss of synchronization is detected in the exemplary embodiment using a hysteresis algorithm, one embodiment of which is shown in FIG. 5e. After synchronization is complete (step 562), the receiver increments a per-lane error hysteresis count (step 566) whenever an invalid symbol is detected on the corresponding lane (step 564), and decrements the error hysteresis count (to a minimum value of zero) whenever two consecutive valid symbols are detected (step 568). If the count reaches a prescribed value (e.g., four) for any lane (step 570), then a loss of synchronization is detected (step 572), the receiver ceases normal reception, and attempts resynchronization (step 574). If the receiver fails to reacquire synchronization after a prescribed period of time (e.g., 100ms) or upon meeting another condition (step 576), then it de-asserts UDI_HPD for a given time (e.g., 100ms) to request the transmitter to restart (step 578) as if a disconnect had occurred.

Single-Lane Mode

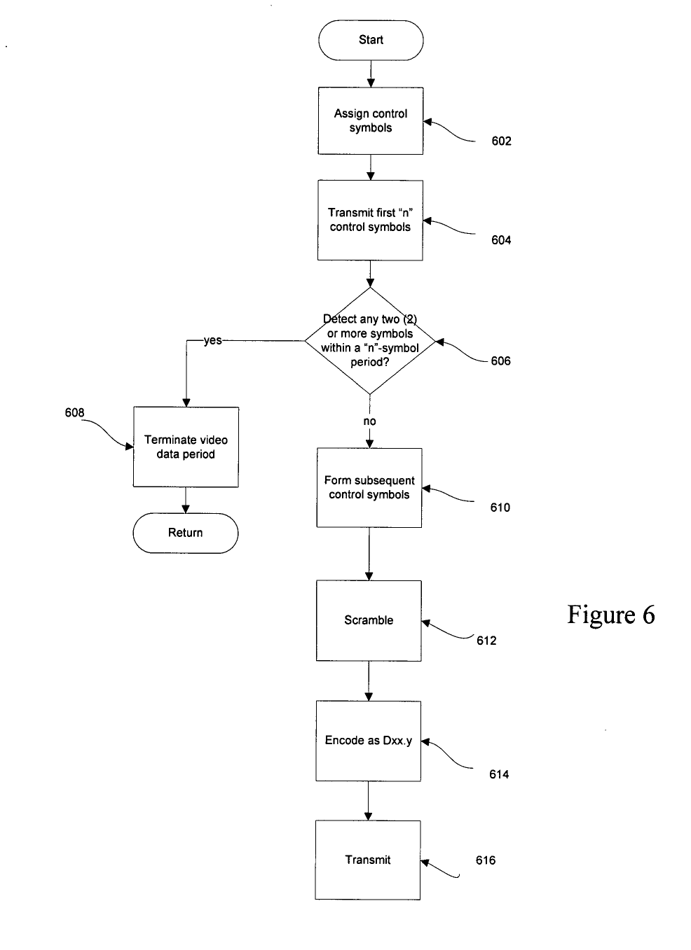

Referring now to FIG. 6, an exemplary embodiment of a single-lane implementation according to the invention is described. In this embodiment, lane 0 is used for the single lane operation. The source may disable the transmitters for lanes 1-3, and the sink may be configured not to attempt data recovery on these lanes. A sink implementing only single lane operation need not implement receivers for lanes 1-3. Moreover, a tethered cable attached to such a sink need not contain connections for lanes 1-3.

The frame format of the embodiment of FIG. 6 follows broadly that of the three-lane usage previously described with respect to FIGS. 5a-5e. Specifically: a) each line commences with at least four control symbols, and control symbols are transmitted on each symbol (pixel) clock outside of periods used for data islands or video data; b) the data island preamble is transmitted for 8 symbol clock periods; c) two data island guard band symbols are transmitted at the start and end of each data island; d) each packet in the data island is transmitted in 64 symbol clock periods; e) the video island guard band is transmitted for two symbol clock periods; and f) video data is formatted as specified for the ×1 Link and transmitted at the rate of one byte per symbol clock period.

In terms of control symbols (FIG. 6), the four control indication bits CTL3:0 are always zero during the first four control symbols of a line. Four distinct K symbols are assigned (step 602), one to each of the four possible values of the two control bits HSYNC and VSYNC. The symbols selected for this embodiment (Table 3) are K28.0, K28.1, K28.2 and K28.3, for ease of decoding.

TABLE 3

| Control Bit Values | Symbol |
|---|---|
| 00 | K28.0 |
| 01 | K28.1 |
| 10 | K28.2 |
| 11 | K28.3 |

The first four control symbols of each line are transmitted using this encoding without scrambling (step 604). The detection of two or more of any of these four symbols within a four-symbol period (step 606) terminates a video data period (meeting requirement f) above) per step 608. Subsequent control symbols in a line (including Data Island preambles) are transmitted by forming an 8 bit data value D7:0 from D0=HSYNC, D1=VSYNC, D3:2=0b00, D7:4=CTL3:0 to form a 8 bit value in the range 0-255 (step 610), scrambled to generate an 8-bit value in the range 0-255 (step 612), encoded as the corresponding Dxx.y symbol per step 614, and transmitted per step 616. If, at any time, the result of scrambling is the symbol D28.0, then the symbol K28.5 is substituted per step 618.

The video island guard band symbol in the illustrated embodiment is selected as K23.7, transmitted twice. It will be appreciated, however, that other symbols and/or transmission protocols may be substituted. The video guard band symbols are not scrambled.

With respect to the data island guard band symbols, four distinct K symbols are assigned, one to each of the four possible values of the two control bits HSYNC and VSYNC. The symbols selected for this are K29.7, K30.7, K28.4 and K28.6. The data island guard band symbols are not scrambled.

For the data island values, a data byte D7:0 is formed from:

DO=HSYNC;

D1=VSYNC;

D2=packet header bit (first 32 symbol clock periods) per the HDMI Specification, 02=0 (second 32 symbol clock periods);

D3=0 for the first symbol of the first packet, D3=1 otherwise;

D4=successive bits of subpacket 0 (including BCH ECC parity bits);

D5=successive bits of subpacket 1 (including BCH ECC parity bits);

D6=successive bits of subpacket 2 (including BCH ECC parity bits); and

D7=successive bits of subpacket 3 (including BCH ECC parity bits).

The result is then scrambled to generate an 8-bit value in the range 0-255, encoded as the corresponding Dxx.y symbol, and transmitted. Note that in contrast to the control symbols, no substitution of D28.0 by K28.5 is performed.

For the video data, the eight bits for each symbol period are scrambled to generate an 8-bit value in the range 0-255, encoded as the corresponding Dxx.y symbol, and transmitted. Note again that in contrast to control symbols, no substitution of D28.0 by K28.5 is performed.

Four-Lane Mode

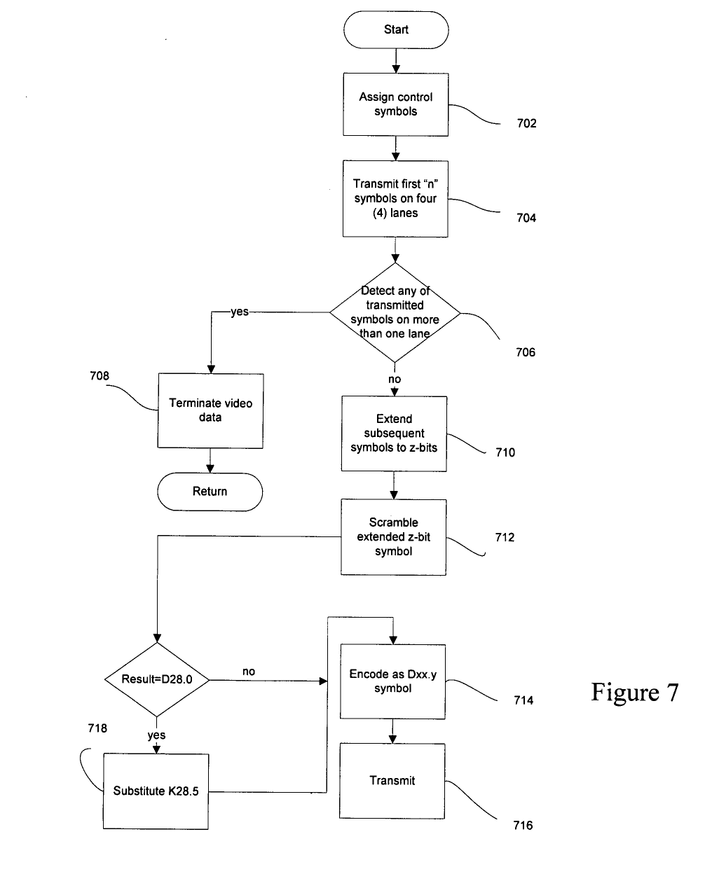

Referring now to FIG. 7, yet another embodiment of the invention is described, specifically wherein four (4) lanes are utilized. Specifically, in this embodiment, all four available lanes are used to transmit data. The frame format follows closely that of the three-lane usage described above with respect to FIGS. 5a-5c. Specifically, a) each line commences with at least four control symbols, and control symbols are transmitted on each symbol (pixel) clock outside of periods used for data islands or video data; b) the data island preamble is transmitted for 8 symbol clock periods; c) the two data island guard band symbols are transmitted at the start and end of each data island; d) each packet in the data island is transmitted in 32-symbol clock periods; e) the video island guard band is transmitted for two symbol clock periods; and f) the video data is formatted for a putative ×4 Link and transmitted at the rate of four bytes per symbol clock period.

It is noted that with respect to item d) above, other alternative packing or transmission schemes that make more optimal use of the bandwidth available may be used, such alternative schemes being readily recognized by those of ordinary skill provided the present disclosure.

In the exemplary embodiment of the four-lane mode (see FIG. 7), four distinct K symbols are assigned per step 702, one to each of the four possible values of the two control bits for each lane (HSYNC and VSYNC for lane 0, CTL1:0 for lane 1, CTL3:2 for lane 2 and CTL5:4 for lane 3). The symbols selected for this embodiment are K28.0, K28.1, K28.2 and K28.3, for ease of decoding, although it will be recognized that others may be used. The first four control symbols of each line are transmitted using this encoding for each lane without scrambling per step 704. The detection of any of these four symbols on more than one lane (step 706) terminates a video data period (meeting the requirements discussed above) per step 708.

Subsequent control symbols in a line (including data island preambles), are transmitted by being extended with zeros to generate an 8 bit value (still in the range 0-3) per step 710, scrambled to generate an 8-bit value in the range 0-255 (step 712), encoded as the corresponding Dxx.y symbol per step 714, and transmitted per step 716. If, at any time, the result of scrambling is the symbol D28.0, then the symbol K28.5 is substituted per step 718.

For video guard band symbols, two (2) distinct K symbols are assigned. The symbols selected for this embodiment are K23.7 (for transmission on data lanes 0 and 2) and K27.7 (for transmission on data lanes 1 and 3), although others may be used. The video guard band symbols are not scrambled.

For data island guard band symbols, four (4) distinct K symbols are assigned, one to each of the four possible values of the 2 control bits for each lane (HSYNC and VSYNC for lane 0, CTL1:0 for lane 1, CTL3:2 for lane 2 and CTL5:4 for lane 3). The symbols selected for this are K29.7, K30.7, K28.4 and K28.6. Note that CTL1:0, CTL3:2 and CTL5:4 are always zero, so the symbol transmitted on lanes 1, 2 and 3 is always K29.7 in this embodiment. The data island guard band symbols are not scrambled.

For data island values, the four bits for each symbol period for each lane (HSYNC, VSYNC, packet header bit and 0/1 bit for lane 0, packet data for lanes 1 and 2) are extended with zeros to generate an 8 bit value in the range 0-15, scrambled to generate an 8-bit value in the range 0-255, encoded as the corresponding Dxx.y symbol and transmitted. The value 0 is scrambled to generate an 8-bit value in the range 0-255, encoded as the corresponding Dxx.y symbol and transmitted on lane 3. In contrast to the control symbols, no substitution of D28.0 by K28.5 is performed.

Note also that alternative packings that would make more optimal use of the bandwidth available may be substituted, as will be recognized by those of ordinary skill.

For the video data, the eight bits for each symbol period for each lane are scrambled to generate an 8-bit value in the range 0-255, encoded as the corresponding Dxx.y symbol and transmitted. Again, no substitution of D28.0 by K28.5 is performed.

Source/Sink Apparatus

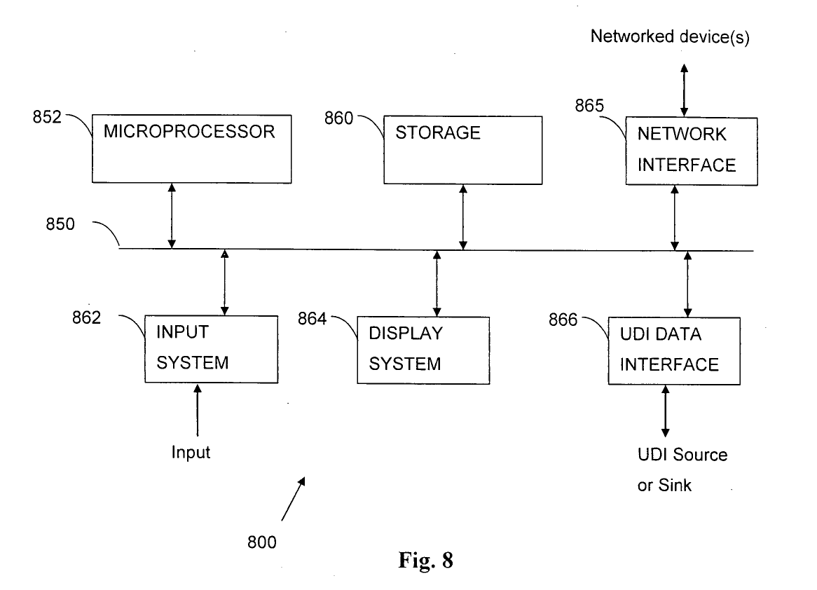

FIG. 8 is a block diagram of an electronic device 800 configured in accordance with one embodiment of the invention. The microprocessor 852 is coupled to memory unit 860 via the bus 850. The memory unit 850 typically includes fast access storage elements including random access memory (e.g., DRAM, SRAM), read-only memory (ROM) as well as slower access memory systems including flash memory and disk drive storage. The bus 850 also electronically couples the input system 862 (e.g., a keypad, mouse, speech recognition unit, touch screen, etc.), display or output system 864, network interface 865, and UDI data interface 866 to the other components of the system, as is well known in the art.

During operation, software instructions stored in the storage unit 860 are applied to the microprocessor 852 (which also may contain its own internal program/data/cache memory), which in turn controls the other components such as the input system 862, display system 864 and interfaces 865, 866. The protocol stack (in the form of software or firmware) causes the systems to perform the various link layer framing and other functions previously described herein. Separate dedicated ICs or ASICs may also be used for one or more of these functions, such as where a separate interface or network chipset or suite is used in conjunction with a host processor. Alternatively, many or even all of these functions can be aggregated on a System-on-chip (SoC) or comparable device of the type well known in the art.

Moreover, the illustrated UDI interface 866 may incorporate the aforementioned unified or harmonized profile functionality as a substantially discrete unit, or may be integrated into other devices (such as the network interface 865).

It will be appreciated that while shown primarily in the context of a UDI External Profile device (i.e., having a UDI interface to an external device), the device 800 of FIG. 8 can embody the “Embedded Profile” as well, such as between the display device 864 and another component of the device 800. Advantageously, the “harmonized” profile described herein can be used to provide each of these functions in a unified fashion, thereby simplifying the device 800 in terms of inter alia, the data link layer protocol stack and framing.

It will further be appreciated that the various methods and apparatus of the present invention can be implemented on a broad range of devices targeting video or other media applications. These devices might include for example mobile devices, personal or laptop computers, handhelds, PMDs, cellular telephones or smartphones, network servers, RAID devices, cable or satellite set-top boxes, DVRs, DVD players, and so forth. Exemplary component applications might include discrete transmitters and/or transcoders (i.e., devices that convert incoming data from a first format or interface to another, such as e.g., from a non-UDI interface to a UDI interface, or alternatively from a UDI interface to a non-UDI interface), repeaters (devices that are used regenerate or pass on signals for purposes of e.g., extending range or speed), as well as transmitters integrated with graphics and video processors. Other exemplary component applications could include discrete receivers, as well as receivers combined with other display-related functionality so as to provide a higher level of component integration. Another potential target application includes video devices with components that integrate both transmitters and receivers, commonly referred to as transceivers or switching devices.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A data device adapted to communicate with a second device over an interface, comprising:
a processor;
a storage device in data communication with said processor;
an interface adapted for data communication with said second device; and
a computer program operative to run on said processor;
wherein said computer program comprises a substantially unified data link layer protocol adapted to support two at least partly heterogeneous device profiles.

2. The data device of claim 1, wherein said data comprises video data, and said protocol comprises a unified display interface (UDI) compliant protocol.

3. The data device of claim 2, wherein said heterogeneous device profiles comprise the UDI Embedded Profile and the UDI External Profile.

4. The data device of claim 1, wherein the data device comprises a unified display interface (UDI) source, and the second device comprises a unified display interface (UDI) sink.

5. A method of unifying a plurality of at least party heterogeneous device profiles, comprising:
identifying two or more of said profiles requiring harmonization;
evaluating the two or more profiles to be harmonized in terms of at least their requirements and capabilities; and
harmonizing the two or more profiles so as to provide at least one common functional entity.

6. The method of claim 5, wherein said heterogeneous device profiles comprise the UDI Embedded Profile and the UDI External Profile, and said evaluating comprises evaluating data link layer protocols associated with respective ones of said Profiles.

7. The method of claim 6, wherein said at least one common entity comprises at least one of: (i) a first implementation of a link layer framing logic, and (ii) a second implementation of a link layer frame parsing logic; and
wherein said first and second implementations of said framing and parsing logic each support each of said device profiles.

8. The method of claim 7, wherein at least one of said implementations comprises using 8B10B symbol encoding to transport video data and related information using a video framing structure associated with only one of said device profiles.

9. A method of operating a device adapted to communicate video data, comprising:
assigning a plurality of control symbols associated with said video data;
transmitting at least some of said control symbols for each of a plurality of data lanes;
determining if any of the plurality of symbols are present on more than one of said plurality of lanes; and
if present, terminating a video data period.

10. The method of claim 9, further comprising transmitting subsequent ones of said control symbols by:
extending at least one of said subsequent symbols to generate an extended value;
scrambling said extended value to generate a second extended value;
encoding said second value as a corresponding symbol; and
transmitting said encoded symbol.

11. The method of claim 9, wherein the device comprises a UDI-compliant device.

12. The method of claim 10, further comprising:
evaluating said second extended value; and
if said second extended value comprises a designated symbol, then substituting a second designated symbol therefor.

13. A video data processing system, comprising:
a video data source; and
a video data sink;
wherein said source comprises a first implementation of a link layer framing logic, and said sink comprises a second implementation of a link layer frame parsing logic, said first and second implementations of said framing and parsing logic each supporting a plurality of device profiles.

14. The system of claim 13, wherein said plurality of device profiles comprise (i) the UDI Embedded Profile; and (ii) the UDI External Profile.

15. The system of claim 13, wherein at least one of said implementations comprises using 8B10B symbol encoding to transport video data and related information using a video framing structure associated with one of said device profiles.

16. The system of claim 13, wherein said link layer framing logic and said link layer frame parsing logic can be compliance-tested using a common testing framework.

17. A data device, comprising:
a processor;
a storage device in data communication with said processor;
a display or rendering device;
an interface adapted for data communication between said processor and said display or rendering device; and
a computer program operative to run on said processor;
wherein said computer program comprises a substantially unified data link layer protocol adapted to support two at least partly heterogeneous device profiles.

18. The device of claim 17, wherein said device comprises a portable computer, said display device comprises a liquid crystal (LCD) or thin-film transistor (TFT) display, and said interface comprises a UDI-compliant interface.
